(19) United States
(12) Patent Application Publication
(10) Pub. No.: US 2025/0190639 A1
(43) Pub. Date: Jun. 12, 2025

(54) METHODS AND SYSTEMS FOR EXCHANGING INFORMATION WITH TOOLS

(71) Applicant: Shaper Tools, Inc., San Francisco, CA (US)

(72) Inventors: ROBERT HEMSLEY, Bremen, ME (US); ILAN ELLISON MOYER, Chapel Hill, NC (US); ADITYA RAO, Oakland, CA (US); SHAWN MITCHELL KIRSCH, Oakland, CA (US); JONATHAN WORTHY HOLLANDER, Berkeley, CA (US)

(73) Assignee: Shaper Tools, Inc., San Francisco, CA (US)

(21) Appl. No.: 18/843,245

(22) PCT Filed: Mar. 2, 2023
(86) PCT No.: PCT/US2023/063626

§ 371 Date: Aug. 31, 2024

Related U.S. Application Data
(60) Provisional application No. 63/268,813, filed on Mar. 3, 2022.

(51) Int. Cl. G06F 30/12

(52) U.S. Cl. CPC G06F 30/12

(57) ABSTRACT

Systems and methods for sharing design data between a remote device and a tool with an enhanced user experience for a user of the tool. Design data is transmitted between the remote device and tool with low latency. Tool may be configured to allow the user to utilize the received design data to execute tasks on the tool with low overhead.

### CROSS-REFERENCE TO RELATED APPLICATION

The present application claims priority to U.S. Provisional Application No. 63/268,813, filed on Mar. 3, 2022, the disclosure of which is incorporated herein by reference for all purposes.

### BACKGROUND

### Field of the Disclosure

The disclosure relates generally to software design systems, fabrication tools, and, more specifically, to systems that facilitate the fabrication workflow by permitting transfers of information (e.g., designs, work environment information, workpiece information) between systems used for design and fabrication tools.

### Description of Related Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Systems permitting creation or modification of designs for fabrication of a part from a workpiece are known in the art. Systems that utilize digital designs to fabricate parts from a workpiece are also known in the art. Existing processes permit systems used for designing to work with systems used for part fabrication. In some cases, design information from the design system is made available to the fabrication system, or workpiece information collected using the fabrication system is made available to the design system. The exchange of information may be achieved using a centralized server that maintains design or workpiece information, making the information available to both design systems and fabrication systems. However, existing systems require process overhead related to one or more of: (1) creating access to intermediate or end systems, (2) identifying the target information to be shared or retrieved, or (3) triggering an action related to information if it is shared by or retrieved from a remote system, each time information is exchanged between systems.

For example, a user may create or modify a design on a remote system. The user may transmit the design (e.g., storing the design in a file) to a folder on a storage drive on an intermediate server or a fabrication system. A user of the fabrication system may retrieve the transmitted design (e.g., using a name of a file associated with the design) from the folder on the storage drive on the intermediate server or the fabrication system. After retrieving the design file, the user of the fabrication system may need to configure the fabrication system to utilize the design for the fabrication of a part.

U.S. Patent Publication No. 2019/0196438 (“Rivers”) describes a system that permits tracking of tool activity from a fabrication system to a design system. Rivers also describes a system that permits collaboration between a design system and a fabrication system. Some of the described systems utilize an intermediate server to store information that is accessed by the design system and the fabrication system—permitting the exchange of information.

### SUMMARY OF THE DISCLOSURE

Embodiments of the disclosure are directed to transfer of design data, workpiece-related information, and work environment related information between a remote device and a tool.

In one implementation, a system includes a remote device and a tool in communication with each other. The remote device may transmit design data to the tool, and, in response to receiving the design data, the tool may be configured to allow a user of the tool to place the design in a tool work environment. A user of the tool may place the design in the tool work environment without needing the search for or select the received design.

In another implementation of the system, the tool may transmit workpiece information or work environment information to the remote device. A user of a remote device may place a design in the tool work environment based on the information received from the tool. The remote device may transmit design data and information related to the position of the design in the tool work environment to the tool. In response to receiving the design data and information, the tool may be configured to allow a user of the tool to perform a task related to the design with the design located in the tool work environment at the location specified by the user of the remote device.

### BRIEF DESCRIPTION OF THE DRAWINGS

FIG. 1 shows an exemplary embodiment including a mobile device and a tool for sharing design information.

FIG. 2 shows an exemplary graphical user interface of a mobile application executing on a mobile device for transmitting design information.

FIG. 3 shows an exemplary graphical user interface of a tool application executing on a tool for receiving design information.

FIG. 4 shows an exemplary graphical user interface of a tool application executing on a tool for using received design information.

FIGS. 5-8 show exemplary user interfaces of a web browser executing on a computer system for transmitting design information.

FIG. 9 shows an exemplary graphical user interface of a tool application executing on a tool for using received design information.

### DETAILED DESCRIPTION

The present description is made with reference to the accompanying drawings, in which various example embodiments are shown. However, many different example embodiments may be used, and thus the description should not be construed as limited to the example embodiments set forth herein. Rather, these example embodiments are provided so that this disclosure will be thorough and complete. Various modifications to the exemplary embodiments will be readily apparent to those skilled in the art, and the generic principles defined herein may be applied to other embodiments and applications without departing from the spirit and scope of the disclosure. Thus, this disclosure is not intended to be limited to the disclosed embodiments but is to be accorded the widest scope consistent with the claims and the principles and features disclosed herein.

Shaper Origin handheld precision router allows a user to cut a pattern specified by a digital design by moving the Origin along a path that roughly follows the pattern while the Origin adjusts the cutting bit to follow the pattern accurately. While the Shaper Origin is presented in portions of the description of various embodiments, any tool with similar capabilities may also implement the described embodiments. In a typical set-up scenario, a user creates a work environment by scanning the workpiece; the work environment represents a coordinate system which may include references related to the workpiece (e.g., workpiece edges, workpiece features (e.g., wood grain pattern, wood knot locations), etc.). The user then selects the digital design stored on the Origin (e.g., from a folder on the Origin) and places the design in a specific location in the work environment (e.g., placing the design at a specific location relative to a workpiece feature). Once the design is placed in the work environment, the user can begin cutting the pattern specified by the digital design; the pattern is cut into the workpiece based on the position of the digital design in the work environment.

Shaper Origin allows a user to work on a digital design on a remote computer (e.g., on a desktop, laptop, or mobile device using 2D or 3D CAD or illustration software) and then transfer the digital design to the Origin for cutting. The transfer of the digital design from the remote computer to the Origin may be direct (e.g., from storage media on the remote computer to storage media on the Origin) or indirect (e.g., from storage media on the remote computer to storage media on an intermediate computer system (e.g., server) and then from the storage media on the intermediate computer system to storage media on the Origin). In some embodiments, data, including digital designs and scanned workpieces, may be transferred via a network using a push model, e.g., from the remote computer to the Origin, a pull model, e.g., to the Origin from the remote computer, or by maintaining data synchronization between folders, e.g., on the remote computer and the Origin. In a typical scenario, once the digital design is moved to the Origin from the remote computer, the user selects the digital design for use in a cutting workflow-placing the selected design in the work environment before cutting the pattern specified by the digital design.

In some embodiments, the user experience may be enhanced by streamlining the transfer of a digital design from a remote computer to the Origin for immediate use. For example, a user of a mobile device may initiate the transfer of a design from a design application to an augmented tool, such as Origin, by selecting a UI element or inputting a command within the design application. Design applications may include native, web browser, or progressive web applications running on a computer or a mobile device.

Prior to or after initiating the transfer, a user may select all or a portion of a design to be transferred. Alternatively, the entire design may be automatically selected for transfer upon receiving a transfer request. Optionally, embodiments may automatically convert design application data structures or files into a format suitable for use on Origin prior to transfer. In response to receiving a user input, the design application sends the design to Origin over a network. In response to receiving this design, an embodiment of Origin automatically enters a placement mode and configures itself to place the received design in the current work environment. Embodiments of this user experience may have Origin configure itself such that it is ready to place the design in the work environment without requiring additional user actions, such as a user manually initiating a placement mode on Origin, manually opening a file browser to locate the design file in a file system, or manually selecting a design file representing the received design. The user of the Origin may be provided an option to specify a position of the design or modify the digital design prior to placing the design in the work environment. For example, the user may be given the option to scale the design size (e.g., double the size of the pattern) or rotate/mirror the design prior to placing the design in the workplace. Alternatively, the position, scale, rotation, or other placement options may be automatically set by Origin upon receiving the design.

In some embodiments, the workpiece (or work environment) information used by the Origin may be shared with the design application on a remote computer or mobile device. The workpiece or work environment information may include physical features related to the workpiece (e.g., workpiece edges, workpiece features, such as wood grain pattern, locations of markers placed on workpiece, and wood knot locations), previously imported digital designs, and digital representations of previously cut areas.

In embodiments of this user experience, a user of Origin or other augmented tool may initiate the transfer of the workpiece information to a design application by selecting a UI element or inputting a command on Origin. Prior to or after initiating the transfer, a user may select all or a portion of a workpiece information to be transferred. Alternatively, the entire workpiece information may be automatically selected for transfer upon receiving a transfer request. In response to receiving this user input, the Origin sends the workpiece information to the design application over a network. In response to receiving this workpiece information, the design application may automatically open the workpiece information for viewing or editing. This may optionally include opening, importing or converting the workpiece information data structure or file into a design application format. The application may open the workpiece information without requiring additional user UI actions in the design application, such as a user manually saving and closing other design projects, manually opening a file browser to locate the workpiece information data in a file system, or manually selecting a file representing the workpiece information.

The design application may use the workpiece information from the Origin to allow a user of the design application to place additional digital designs at specific locations in the work environment (e.g., avoiding knots or defects in the workpiece when selecting where to place the design in the work environment) and to modify digital designs previously placed in the work environment. After editing the workpiece information in the design application, the user may initiate a transfer of digital design data representing any modifications from the design application and send the digital design from the design application back to the Origin. In these embodiments, the user of the Origin does not have to place the digital design in the work environment; modifications made in and received from the design application would automatically be reflected in the work environment on the Origin. This workflow further streamlines the sharing of digital design between the remote computer and the Origin by not requiring the user of the Origin to have to place the digital design in the work environment. In some embodiments, the work environment information (received from the Origin) may include information related to current position of the Origin in the work environment—this allows the user of the remote computer to see where the Origin is currently located when deciding where to place the digital design in the work environment.

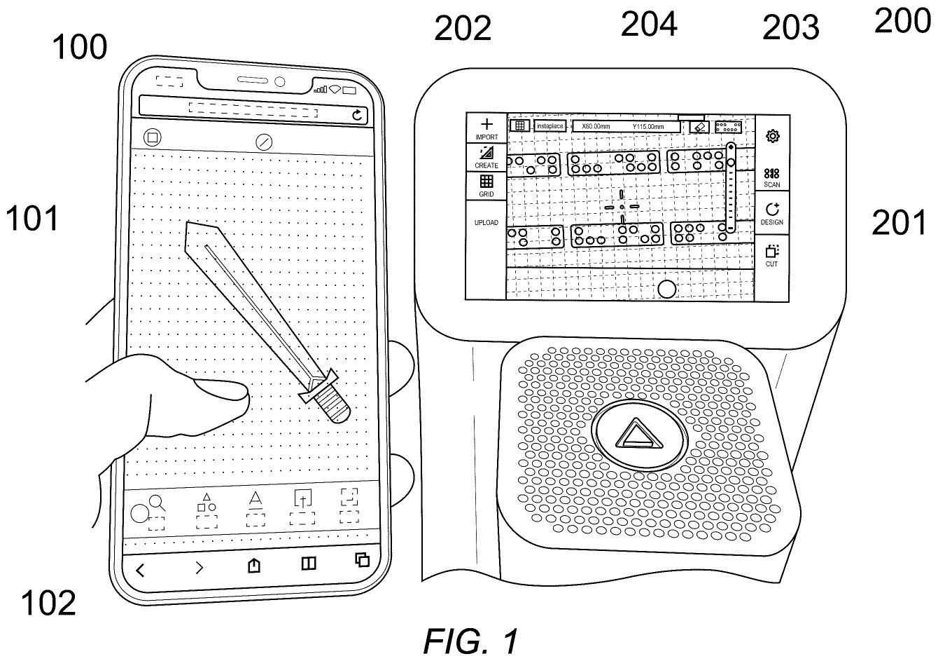

FIG. 1 illustrates an exemplary configuration showing a view of a mobile device 100 and a portion of a tool 200 (e.g., Shaper Origin with display 201). In some embodiments, a mobile application may execute on a mobile operating system using one or more processors and one or more memories of mobile device 100. The mobile application may render a graphical user interface (“GUI”) including an illustration of a design 101 (“sword”). The mobile application GUI may include one or more icons 102 allowing a user of the application to create (e.g., shapes, free-hand draw), modify, annotate (e.g., add text), or otherwise interact with the design 101. In some embodiments, the tool 200 may include a display 201. In some embodiments, display 201 may show a GUI associated with a tool application executing on a tool operating system using one or more processors and one or more memories of the tool 200. The tool application GUI (on display 201) may include icons 202 and 203 to interact with designs (“Import,” “Create,” “Grid,” “Upload”; 202) or to execute tool actions (“Scan,” “Design,” “Cut”; 203). The tool application 201 GUI may display tool-related information 204, for example, current location of a cutting bit in the tool (e.g., providing XY coordinates), call-to-action buttons, control sliders (e.g., to change the zoom of the workpiece portion displayed), or portion of an image of the workpiece (e.g., captured by an on-tool camera) showing features (e.g., markers) on the workpiece.

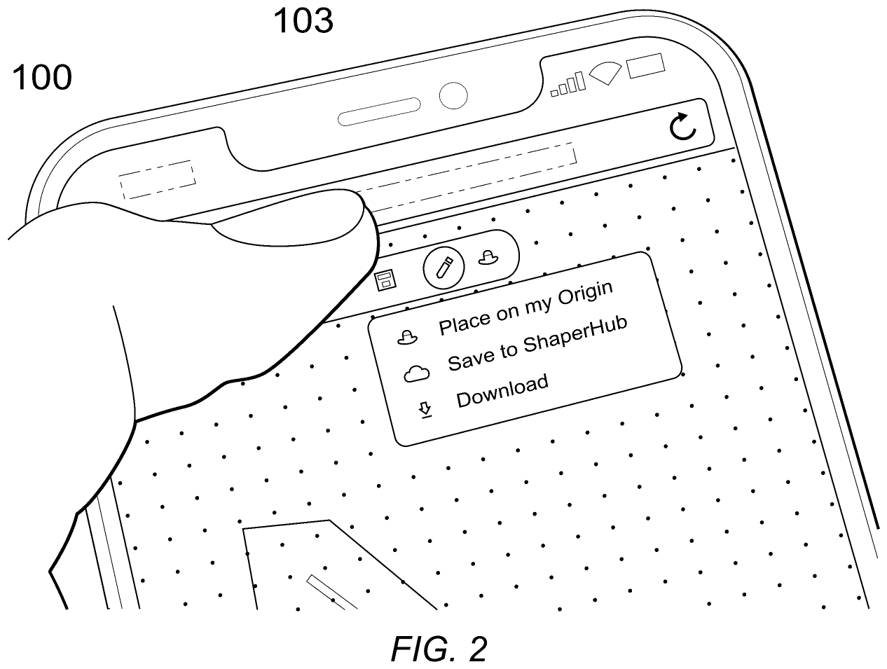

FIG. 2 illustrates an exemplary close-up view of the mobile application GUI on mobile device 100. The mobile application GUI may include an action icon 103 (“pencil”) that allows a user to select an action associated with the design 101. In some embodiments, the action may include an option (“Place on my Origin”) to transfer design 101 to the tool 200 such that the design is ready for placement into the tool work environment by the user of the tool. In some embodiments, the design is configured for placement in the work environment without additional actions (e.g., selection of the design) by the user—the user may register the design at a location of their choosing using a physical button on the tool or a software button on the tool application GUI. In some embodiments, the action may include an option (“Save to ShaperHub”) to transfer design 101 to a remote folder (e.g., an in-cloud folder associated with the user of the mobile device 100). In some embodiments, a user of tool 200 may retrieve design 101 from the remote folder by accessing the cloud system (e.g., using access credentials) and navigating to the folder to select the design for downloading to the tool. In some embodiments, the action may include an option (“Download”) to download design 101 to the mobile device 100 if design 101 is being viewed/edited on mobile device 100 while still being stored on a system remote from the mobile device.

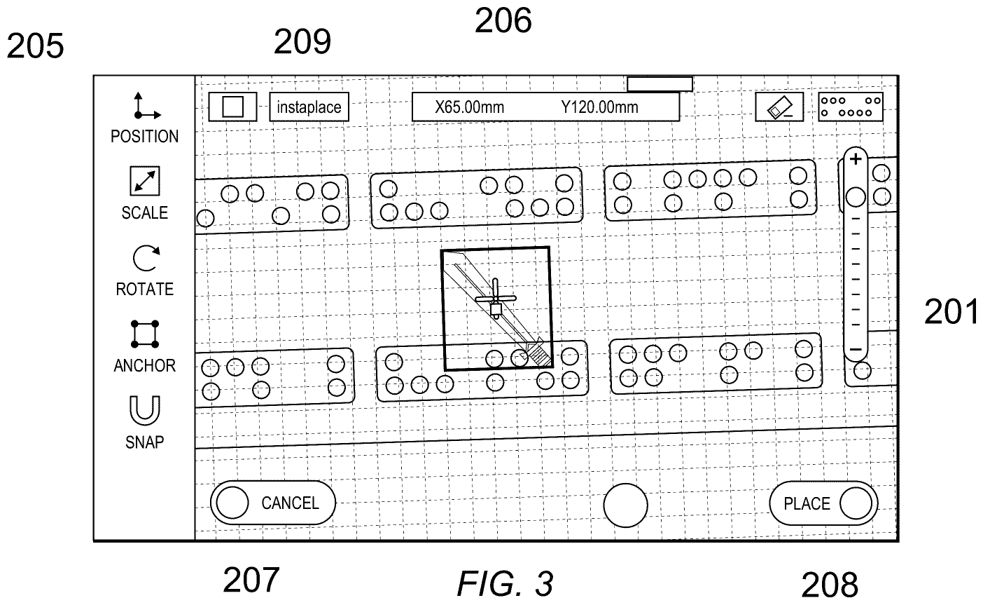

FIG. 3 illustrates an exemplary view of the tool application GUI (on display 201) showing icons 205, tool information 206, and additional control options 207 and 208. In the configuration illustrated in FIG. 3, the tool is configured in design placement mode. In the design placement mode, the design 101 is selected (“sword” design in box) for placement by the user into the work environment at the location illustrated in the GUI. In some embodiments, icons 205 may allow a user of tool 200 to select actions; the actions may allow the user to perform one or more of: place the design 101 at a user-provided location in the work environment (“Position”), scale the design 101 prior to placement (“Scale”), rotate the design 101 prior to placement (“Rotate”), select an anchor point associated with the design 101 to use as a reference for the position of the design in the work environment (“Anchor”), or snap the design 101 to a grid associated with the work environment (“Snap”).

In some embodiments, the user can select to register the design 101 in the work environment using the “Place” button 208 in the GUI (or use a physical button on the tool, e.g., on a handle of the tool). The tool application may allow the user to move the tool to a given location on the workpiece while the tool application tracks the location of the tool (e.g., position of the tool camera, position of the cutting bit) using features (e.g., markers) on the workpiece. In some embodiments, the tool application GUI may provide the user the option to exit the design placement mode by selecting the “Cancel” button 207 in the GUI (or use a physical button on the tool). In some embodiments, the tool application may configure the tool to be in the design placement mode by selecting the “instaplace” button 209. While the tool application is in the design placement mode, a user of mobile device 100 may transfer a design from the mobile application to the tool application for placement without further action from the user of the tool-hence, the description of “instaplace” for button 209.

In some embodiments, the design placement mode allows the user of tool 200 to work efficiently with different designs without having to search for or select each design from a local or remote location (e.g., folder) for placement in the work environment before executing a task (e.g., cutting the design on the workpiece). In some embodiments, the user experience on a tool is streamlined such that the user of the tool can focus on completing tool tasks (e.g., cutting) without needing to manually identify each design (e.g., in a folder of the tool file system using the tool application) before placing the design in a work environment. In some embodiments, the user experience on a tool is enhanced by providing the user of the tool a familiar interface (e.g., using a mobile application on their mobile device) to select designs for use to complete tasks on the tool—only a basic familiarity with the tool application's user interface is required (especially if the tool is an automated cutting tool); searching for or manually selecting designs using the tool application's user interface is not required. In some embodiments, a first user on a first computer may transmit multiple designs to a second user on a tool in a serial manner. After the second user finishes a task related to one design, the first user sends the next design to the tool from the first computer, and the second user places the next design in the tool work environment without needing to locate/identify the received (next) design. In some embodiments, a tool may maintain a queue of received designs that allows a user of the tool to place/cut the received designs one at a time before the next design in the queue is available for placement/cutting. This may allow a tool user to place all received designs before moving to cut the placed design. Alternatively, a tool user may place a design, cut the placed design, and then move to placing the next design in the queue prior to cutting the next design-moving serially through the queue with placement and cutting designs before moving to the next design. In some embodiments, the tool design queue may be created by a single remote user sending designs to the tool queue, or the queue may be created based on input from multiple remote users sending designs to the tool queue. This allows the completion of complex tasks with many different designs with low overhead on tool setup for each design.

In some embodiments, the implementation of the tool placement mode (e.g., by selecting “instaplace” button 209) may include one or more of: communicating to a remote computer (e.g., a server or mobile device 100) that the tool application is in a configuration to receive a design, providing credentials to allow the tool application to access a service (e.g., a service executing on a remote computer to permit discovery of the tool by other computers, for example, mobile device 100), communicating to a remote computer that tool 200 is powered on, communicating to a remote computer that tool 200 has access to an internet or intranet, or the like. In some embodiments, while the design placement mode, the tool application may allow a remote computer (e.g., mobile device 100 using the mobile application) to access information from the tool, including, for example, information related to the workpiece (e.g., data related to features on the workpiece; workpiece geometry, etc.) or information related to the work environment in use by the tool application.

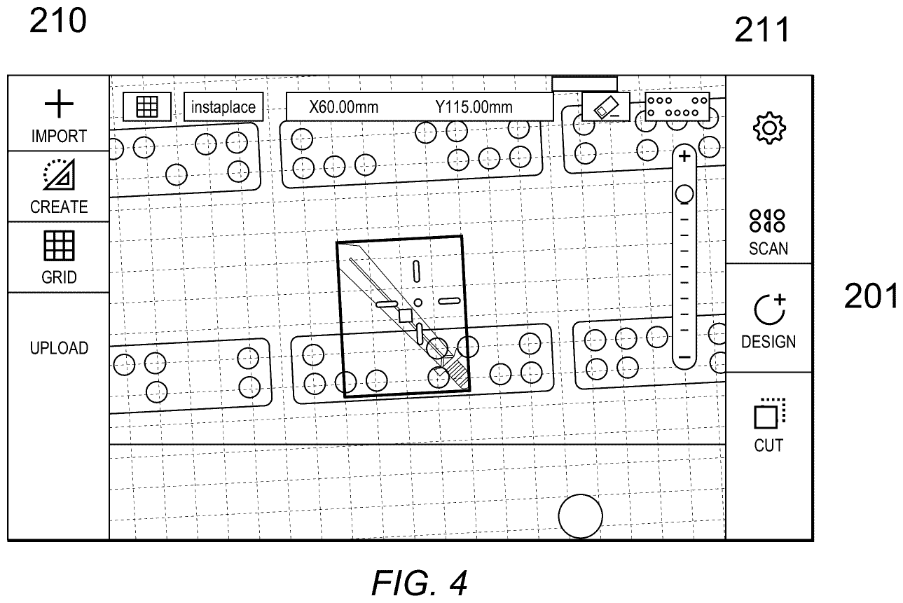

FIG. 4 illustrates an exemplary view of the tool application GUI (on display 201) showing icons 210 and 211. In the configuration illustrated in FIG. 4, the tool 200 is configured in a design mode (e.g., after the design 101 has been placed at a location within the work environment). Once the design 101 has been placed at a fixed location in the work environment, the user of the tool may be provided options using icons 211; the actions implemented by selecting an icon 211 may allow the user to perform one or more of: cut the design into the workpiece using the cutting bit from a cut mode of the tool (“Cut”), add/modify designs in the work environment from the design mode (as shown in FIG. 4) of the tool (“Design”), scan a portion of the workpiece from a scan mode of the tool (to update or modify the work environment; “Scan”), or access another setting for the tool using the tool application (gear icon). The user of the tool may be provided options using icons 210; the actions implemented by selecting an icon 210 (e.g., in design mode) may allow the user to perform one or more of: import a design from a local or remote location (e.g., manually selecting the design for placement; “Import”), create a design in the work environment (“Create”), add a grid to the work environment (“Grid”), or upload information from the tool application (e.g., workpiece information, work environment information; “Upload”) to a remote computer.

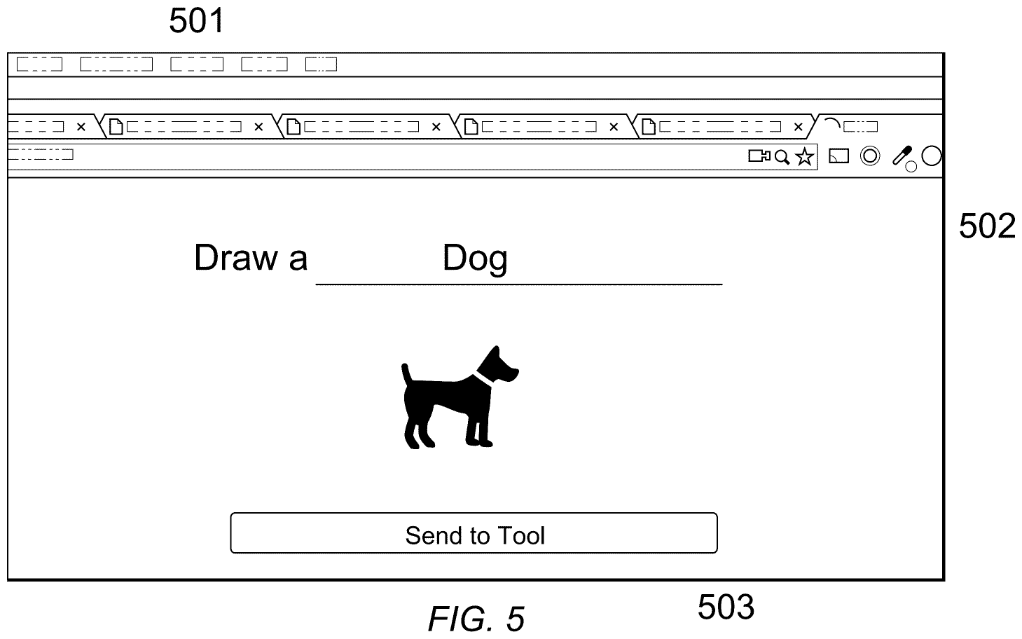

In FIG. 5, an exemplary user interface 501 (UI) of a web browser executing in an operating system (e.g., Chrome browser executing in macOS on an Apple MacBook) is illustrated. In the illustrated embodiment, UI 501 allows a user to select a design (e.g., “Dog”) using an input field 502. In some embodiments, the web browser may include a design environment (e.g., from a CAD application executing in the web browser or executing at a remote location and being rendered at the web browser) to allow the user to create or modify designs within UI 501. In some embodiments, the user may send the design to a tool using a browser button 503. As discussed above, the tool may receive the design while the tool application is configured in a design mode such that the tool user does not need to take any additional steps to select the received design prior to placing the received design in the tool application's work environment.

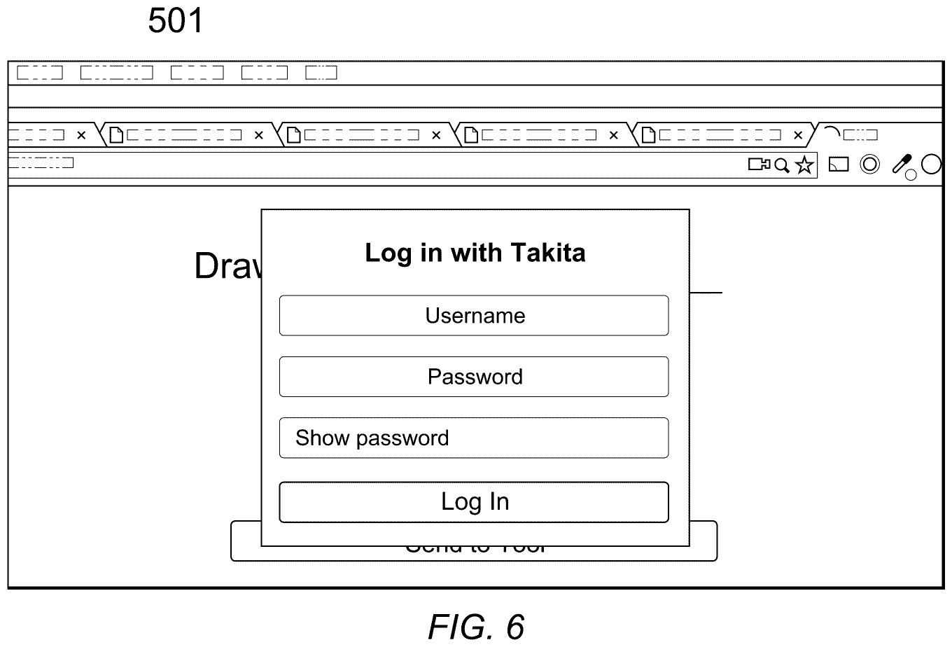

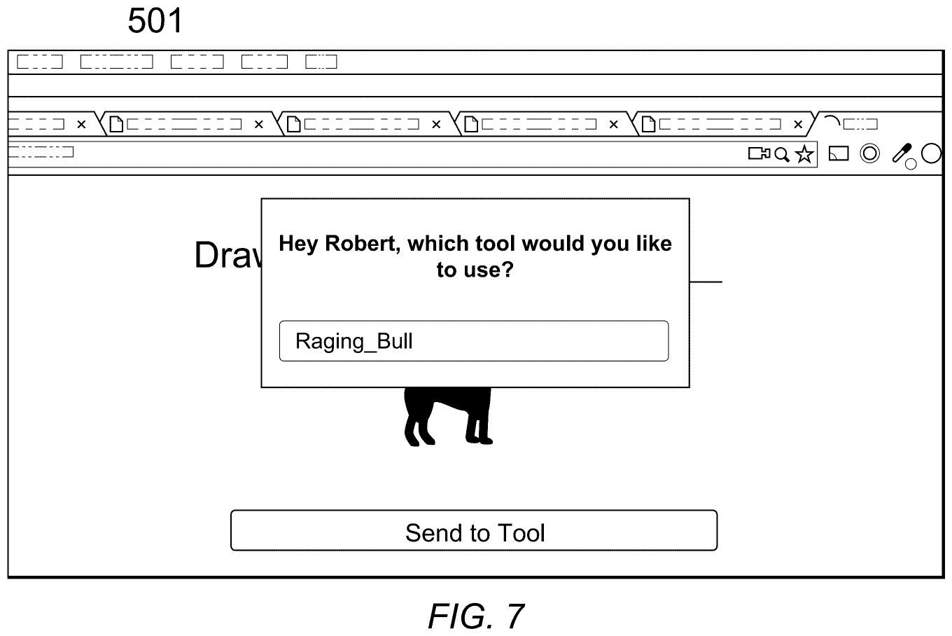

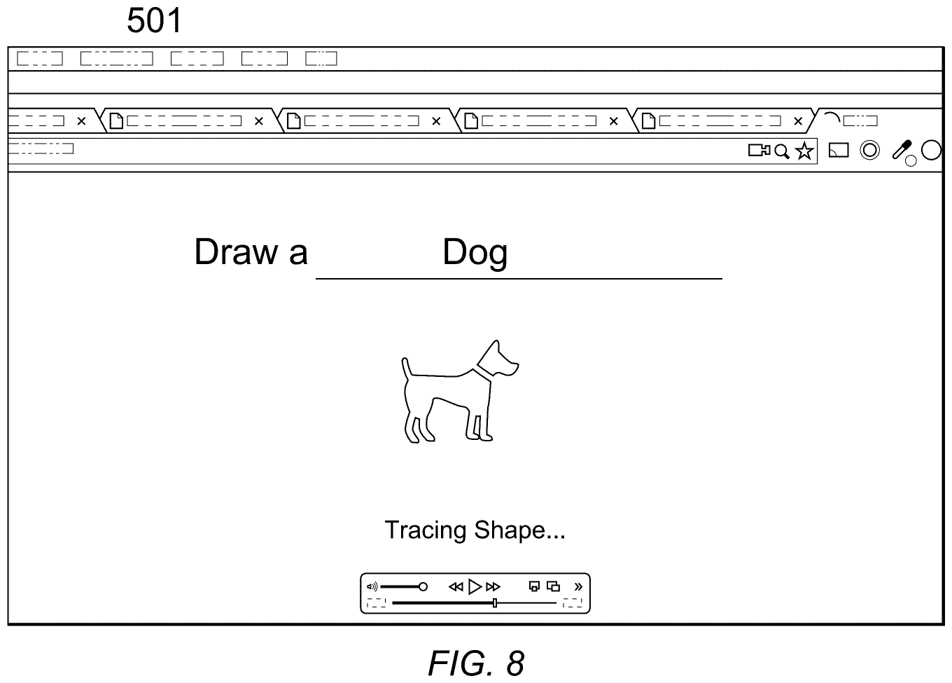

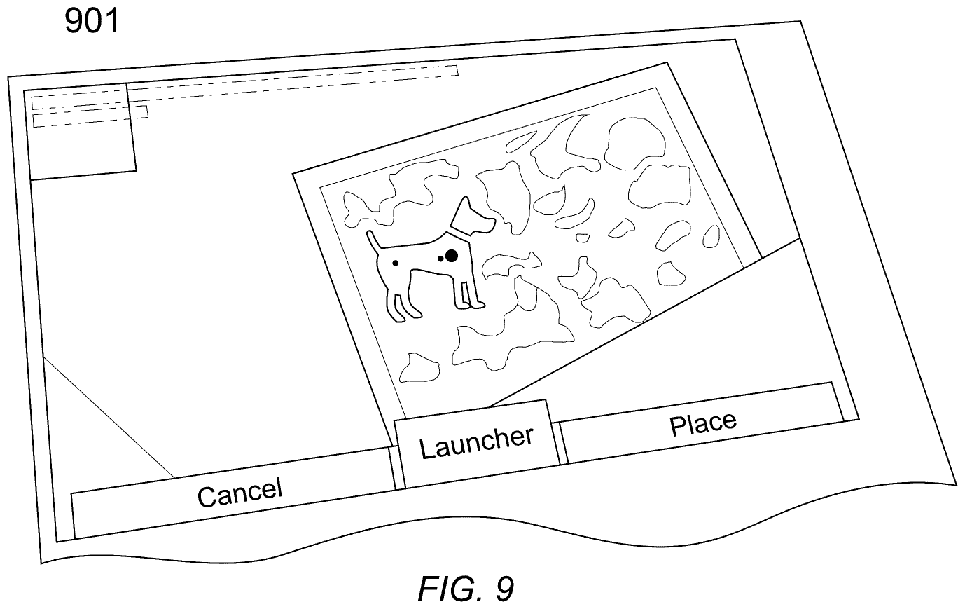

In FIG. 6, an exemplary UI 501 of a web browser shows an authentication interface to permit a user of the web browser to enter their credentials to log into a service. In some embodiments, applications that provide design information to tools or receive workpiece/work environment information from tools authenticate into a service which permits exchange of information between remote applications and applications executing on tools. Similarly, applications executing on tools authenticate into the service to allow remote applications to send design information to the tool or to send workpiece/work environment information to remote applications. As illustrated in FIG. 7, the user of the web browser may be provided a list of tools that are configured to receive design information (e.g., configured in design placement mode) when the user selects to send the design to a tool. In some embodiments, a design may be converted to a tool-specific format (e.g., SVG) from a format used by the design application prior to sending the design to a tool as illustrated in FIG. 8. FIG. 9 illustrates an exemplary view of a tool application GUI 901 on a display of a tool showing the received design ready for placement into the work environment.

In some embodiments, exchange between an application executing on a remote computer and an application executing on a tool may be permitted based on one or more of: proximity (e.g., based on exchange of ultrasonic signals, wireless radio signal strength, Bluetooth connectivity, Ultra Wideband connectivity, or the like), connection to a common network (e.g., PAN, LAN, WLAN), verification of an access code (e.g., QR code, alpha-numeric passcode, or the like), or authentication to a common service. In some embodiments, an application executing on a tool may permit exchange of data from an application executing on a remote computer without any additional verification or authentication—e.g., the tool application may accept incoming data from any remote application from a remote computer.

The design application may convert the digital design to a format compatible with the tool for use in the work environment. For example, the remote computer may convert the digital design from data structures representing design data to SVG or other vector graphics file format for use on the tool prior to transmitting the design data. In another example, digital designs may be represented in a design application as a sequence of transformation or operations performed on data structures, such as Operational Transforms (OTs) or Conflict-Free Replicated Data Type (CRDT), that allow multiple users to simultaneously view and edit designs and merge the cumulative changes into a single data structure without conflicts or inconsistencies. These transformation sequences may be stored separately or in groups as database records in the design application or a remote synchronization service. In another example, the tool may convert the received design data into a format compatible with the tool after receiving the digital design from the remote computer. The tool may permit placement of the received design data in the work environment using one or more anchor points identified for the digital design. The remote computer may specify which digital design anchor point is to be used by the tool for placement of the digital design in the work environment.

The digital design may be sent from the remote computer to the tool using any protocol. For example, the digital design may be sent using WebSocket or HTTP(S) connection over a TCP/IP connection. The digital design may be sent using a wired (e.g., ethernet, USB) or wireless (e.g., WiFi, WiFi direct, Bluetooth) connection between the remote computer and the tool. The digital design may be sent using a push notification workflow (e.g., Apple Push Notification service, Chrome Notifications and Push APIs, Android notification API, custom API, or a pull protocol emulating a push service, such as long polling). The digital design may be sent using an intermediate computer system (e.g., intermediate server) in on-premises or in-cloud (e.g., AWS, Azure) infrastructure.

The described workflows permit modifications and editing of digital designs on a remote computer before transferring the design data to a tool for fabrication. The streamlined workflows permit near instantaneous transfer of design data from a remote computer to the tool. For example, design data may be transferred from the remote computer to the tool in less than 30 seconds, 20 seconds, 10 seconds, 5 seconds, 2 seconds, 1 second, 500 milliseconds, 200 milliseconds, 100 milliseconds, or 50 milliseconds between initiating transfer from the remote computer and having the tool configured for placement of the digital design or configured with the digital design placed already in the work environment.

The remote computer or tool (e.g., Origin) may be a computer system that comprises one or more processors, program code stored in a non-transitory computer readable medium (e.g., one or more memories), and an I/O subsystem. The I/O subsystem may include, e.g., a keyboard, mouse, GUI, touchscreen, or other interfaces for input, and, e.g., an LED or other flat screen display, or other interfaces for output. Program code may be stored in non-transitory media such as main memory, including volatile memory such as random access memory (RAM) or non-volatile memory such as read only memory (ROM), or secondary memory, including solid state drives, hard disks or optical disks. One or more processors reads program code from one or more non-transitory media and executes the code to enable the computer system to accomplish the methods performed in the embodiments herein. Applications may be implemented as compiled, just-in-time compiled, or interpreted code, such as Javascript, or bytecode, such as WebAssembly, executing in a native operating system or within a virtual machine, including virtual machines included in web browsers and operating system-provided webviews. The processors may communicate with external networks via one or more communication interfaces, e.g., a network interface card, WiFi transceiver, etc. A bus communicatively couples the processors, the memories, the I/O subsystem, the communication interfaces, and peripheral devices. The embodiments described herein may be implemented using, without limitation: systems using one or more computing devices, computer-implemented methods, combinations of one or more apparatuses, or one or more non-transitory computer readable media.

The above disclosure describes one or more workflows using a Shaper Origin as an exemplary tool. The tool may be any suitable tool working with a remote computer for the transfer of digital designs.

Those skilled in the art will understand that some or all of the elements of embodiments of the disclosure, and their accompanying operations, may be implemented wholly or partially by one or more computer systems including one or more processors and one or more memory systems. Some elements and functionality may be implemented locally, and others may be implemented in a distributed fashion over a network through different servers, e.g., in client-server fashion, for example.

Those skilled in the art will recognize that, in some embodiments, some of the operations described herein that do not involve data processing may be performed by human implementation, or through a combination of automated and manual means.

Although the disclosure may not expressly disclose that some embodiments or features described herein may be combined with other embodiments or features described herein, this disclosure should be read to describe any such combinations that would be practicable by one of ordinary skill in the art. Unless otherwise indicated herein, the term “include” shall mean “include, without limitation,” and the term “or” shall mean non-exclusive or in the manner of “and/or.”

### APPENDIX—PSEUDO CODE

In an exemplary embodiment, a workflow describing the transfer of a design from a remote device to a tool may include the following steps:
1. Selection of design on remote device
2. (Optional) Conversion of design to a format compatible with the tool (e.g., on remote device, intermediate device, or tool)
3. (Optional) Transfer of design from the remote device to an intermediate device (e.g., server)
4. Transfer of design (e.g., directly from remote device, from intermediate device) to tool
5. (Optional) Selection of transferred design from design repository (e.g., folder) on tool
6. Placement of selected design in work environment
   In an exemplary embodiment, a workflow describing the transfer of a design from a remote device to a tool may include the following steps:
1. Selection of design on remote device
2. (Optional) selection of tool (e.g., based on user credentials)
3. Transfer of design from remote device to tool; the tool configured for placement of the design in the work environment after receiving the design
4. Placement of received design by user of the tool
   In an exemplary embodiment, a workflow describing the transfer of a design from a remote device to a tool may include the following steps:
1. Transfer of work environment information from tool to remote device
2. Selection of design on remote device
3. Placement of design in work environment by a user of remote device
4. (Optional) selection of tool (e.g., based on user credentials)
5. Transfer of design and placement information from remote device to tool
   a. Tool configured with design located in the work environment based on placement information from remote device after receiving the design and placement information

### Embodiments

1. A system for transferring design data between a remote device and a tool, wherein the remote device comprises:
one or more memories storing instructions;
one or more processors, operably coupled to the one or more memories;
a communication interface operably coupled to at least one of the one or more processors; and
an input device operably coupled to at least one of the one or more processors, wherein at least one of the one or more processors execute the instructions to cause the system to:
receive a first input, via the input device, identifying a digital design; and
transmit design data, via the communication interface, to the tool, wherein the design data is based at least in part upon the digital design, and, in response to receiving the design data, the tool is configured in a mode to permit a user of the tool to place a representation of the digital design in a work environment of the tool.
2. The system of embodiment 1, wherein the instructions when executed cause the system to:
receive a second input, via the input device, identifying the tool.
3. The system of any one of the preceding embodiments, wherein the design data is transmitted using a WebSocket communication protocol.
4. The system of any one of the preceding embodiments, wherein the tool is in the configured mode less than 30 seconds, 20 seconds, 10 seconds, 5 seconds, 2 seconds, 1 second, 500 milliseconds, 200 milliseconds, 100 milliseconds, or 50 milliseconds after transmitting the design data.
5. The system of any one of the preceding embodiments, wherein the tool provides instructions to perform a cut on a workpiece based at least in part upon the received design data.
6. A method for transferring design data between a remote device and a tool, comprising: receiving a first input identifying a digital design; and
transmitting design data to the tool, wherein the design data is based at least in part upon the digital design, and, in response to receiving the design data, the tool is configured in a mode to permit a user of the tool to place a representation of the digital design in a work environment of the tool.
7. A system for transferring design data between a remote device and a tool, wherein the remote device comprises:
one or more memories storing instructions;
one or more processors, operably coupled to the one or more memories;
a communication interface operably coupled to at least one of the one or more processors; and
an input device operably coupled to at least one of the one or more processors, wherein at least one of the one or more processors execute the instructions to cause the system to:
receive a first input, via the input device, identifying a digital design; and
transmit design data, via the communication interface, to the tool, wherein the design data is based at least in part upon the digital design, and, in response to receiving the design data, the tool is configured to permit a user of the tool to place a representation of the digital design in a work environment of the tool.
8. A system for transferring design data between a remote device and a tool, wherein the remote device comprises:
one or more memories storing instructions;
one or more processors, operably coupled to the one or more memories;
a communication interface operably coupled to at least one of the one or more processors; and
an input device operably coupled to at least one of the one or more processors, wherein at least one of the one or more processors execute the instructions to cause the system to:
receive a first input, via the input device, identifying a digital design; and
transmit design data, via the communication interface, to the tool, wherein the design data is based at least in part upon the digital design, and, in response to receiving the design data, the tool is configured with a representation of the digital design placed in the work environment.

What is claimed is:

1. A system for transferring design data between a remote device and a tool, wherein the remote device comprises:
one or more memories storing instructions;
one or more processors, operably coupled to the one or more memories;
a communication interface operably coupled to at least one of the one or more processors; and
an input device operably coupled to at least one of the one or more processors, wherein at least one of the one or more processors execute the instructions to cause the system to:
receive a first input, via the input device, identifying a digital design; and
transmit design data, via the communication interface, to the tool, wherein the design data is based at least in part upon the digital design, and, in response to receiving the design data, the tool is configured to permit a user of the tool to place a representation of the digital design in a work environment of the tool or the tool is configured with a representation of the digital design placed in the work environment.

2. The system of claim 1, wherein the instructions, when executed, cause the system to:
receive a second input, via the input device, identifying the tool.

3. The system of claim 1, wherein the design data is transmitted using a WebSocket communication protocol.

4. The system of claim 1, wherein the tool is configured in less than 30 seconds, 20 seconds, 10 seconds, 5 seconds, 2 seconds, 1 second, 500 milliseconds, 200 milliseconds, 100 milliseconds, or 50 milliseconds after the design data is transmitted.

5. The system of claim 1, wherein the tool comprises:
second one or more memories storing second instructions;
second one or more processors, operably coupled to the second one or more memories;
a second communication interface operably coupled to at least one of the second one or more processors; and
a second input device operably coupled to at least one of the second one or more processors, wherein at least one of the second one or more processors execute the second instructions to cause the system to:
before the design data is transmitted, configure the second communication interface to receive design data.

6. The system of claim 1, wherein the tool comprises:
second one or more memories storing second instructions;
second one or more processors, operably coupled to the second one or more memories;
a second communication interface operably coupled to at least one of the second one or more processors; and
a second input device operably coupled to at least one of the second one or more processors, wherein at least one of the second one or more processors execute the second instructions to cause the system to:
provide information that causes an actuator of the tool to cut a portion of a workpiece based at least in part upon the received design data.

7. The system of claim 1, wherein the tool is configured without any additional input from the user of the tool.

8. The system of claim 1, wherein the tool comprises:
second one or more memories storing second instructions;
second one or more processors, operably coupled to the second one or more memories;
a second communication interface operably coupled to at least one of the second one or more processors; and
a second input device operably coupled to at least one of the second one or more processors, wherein at least one of the second one or more processors execute the second instructions to cause the system to:
in response to a user input on the remote device, configure the tool to receive the design data.

9. The system of claim 8, wherein the user input is the first user input.

10. The system of claim 1, wherein the tool comprises:
second one or more memories storing second instructions;
second one or more processors, operably coupled to the second one or more memories;
a second communication interface operably coupled to at least one of the second one or more processors; and
a second input device operably coupled to at least one of the second one or more processors, wherein at least one of the second one or more processors execute the second instructions to cause the system to:
transmit information related to a work environment of the tool to the remote device.

11. The system of claim 10, wherein the information is transmitted from the tool before the design data is transmitted from the remote device.

12. A method for transferring design data between a remote device and a tool, comprising:
receiving a first input identifying a digital design; and
transmitting design data to the tool, wherein the design data is based at least in part upon the digital design, and, in response to receiving the design data, the tool is configured to permit a user of the tool to place a representation of the digital design in a work environment of the tool or the tool is configured with a representation of the digital design placed in the work environment.

13. The method of claim 12, wherein the design data is transmitted using a WebSocket communication protocol.

14. The method of claim 12, wherein the tool is configured for placement of the representation of the digital design in less than 30 seconds, 20 seconds, 10 seconds, 5 seconds, 2 seconds, 1 second, 500 milliseconds, 200 milliseconds, 100 milliseconds, or 50 milliseconds after the design data is transmitted.

15. The method of claim 12, wherein the tool is configured without any additional input from the user of the tool.

16. One or more non-transitory computer-readable media storing instructions for transferring design data between a remote device and a tool, wherein the instructions, when executed by one or more computing devices, cause at least one of the one or more computing devices to:
receive a first input identifying a digital design; and
transmit design data to the tool, wherein the design data is based at least in part upon the digital design, and, in response to receiving the design data, the tool is configured to permit a user of the tool to place a representation of the digital design in a work environment of the tool or the tool is configured with a representation of the digital design placed in the work environment.

17. The non-transitory computer-readable media of claim 16, wherein the design data is transmitted using a WebSocket communication protocol.

18. The non-transitory computer-readable media of claim 16, wherein the tool is configured for placement of the representation of the digital design in less than 30 seconds, 20 seconds, 10 seconds, 5 seconds, 2 seconds, 1 second, 500 milliseconds, 200 milliseconds, 100 milliseconds, or 50 milliseconds after the design data is transmitted.

19. The non-transitory computer-readable media of claim 16, wherein the tool is configured without any additional input from the user of the tool.
